(19) United States
(12) Patent Application Publication
(10) Pub. No.: US 2007/0010941 A1
(43) Pub. Date: Jan. 11, 2007

(54) Land navigation system

(76) Inventor: David C. Marsh, Long Grove, IL (US)

Correspondence Address: HITCHCOCK EVERT LLP, P.O. BOX 131709, DALLAS, TX, 75313-1709, US

(21) Appl. No.: 11/176,068

(22) Filed: Jul. 7, 2005

(51) Int. Cl. G01C 21/30

(52) U.S. Cl. 701/209; 701/200; 701/211

(57) ABSTRACT

A navigation unit and system for land navigation particularly useful for vehicle travel. The navigation unit includes a routing program and programs to be used in conjunction with the routing programs. The programs used in conjunction with the routing program process current traffic information for segments of mapping information. The programs provide for a dynamic road speed sensitivity computation which allows the display of current speeds for various segments of mapping information which can be used to display a selected route with a parameter, such as estimated time for the trip, for the route computed based on current travel information. The unit also can contain a program for allowing the user to set an alert value for a parameter, and the program will alert the user when the current route satisfies the alert requirements, and computes one or more alternate routes that the user can select and display.

### TECHNICAL FIELD OF THE INVENTION

The invention relates to land navigation systems. In a preferred embodiment, the invention relates to a navigation device employing a GPS device which utilizes traffic information in displaying routes and/or route determinations for vehicles.

### BACKGROUND OF THE INVENTION

Global positioning technology is the basis of the global positioning system (GPS) which is a satellite system. GPS provides specially coded satellite signals that can be processed in a GPS receiver, enabling the receiver to compute position, velocity and time. Navigation units can include a GPS receiver, a computer processor, and a database of additional information, such mapping information. Navigation units are used by outdoorsmen to locate and to navigate to desired destinations. Navigation units are also used by operators of vehicles to locate their current location and to navigate to desired destinations. Navigation units are also used for informational purposes such as determining the distance between various locations and planning of trips.

Navigation units used in vehicles frequently utilize a relationship database of map information. The mapping information may include many different types of information, such as, type of roadway, intersections, posted speed limits, average actual speeds, addresses, points of interest, one way roads, etc. Mapping information can also include geographic information such as location of rivers, lakes, altitude at various locations, etc. Frequently, the map data is correlated to nodes and segments. Nodes for example would be intersections where there are options to change the direction of travel. Segments for example, would be sections of road between nodes.

Other types of navigation units may not use GPS. For example, a navigation system can include map data and plot routes from one point to another. Some units measure vehicle direction, distance traveled, speed, turns, changes in vehicle speed and direction, distance traveled during various segments. The inputs related to vehicle movement can be associated with the map data to indicate progress along the route

While navigation units are useful for providing route information from baseline values, e.g. speed limits on sections of road, they have not adequately addressed the desire to provide information about abnormal current conditions affecting the route, and providing the user with alternate routes to the destination.

### SUMMARY OF THE INVENTION

The invention has a number of embodiments. In one embodiment, the invention is a navigation unit which has a central processor unit, a communication unit, one or more user input devices, one or more output devices, and a relationship database. The relationship database contains map information and can include stored inputs from the user such as preferences for routes and alert values. The processor unit is programmed to determine a route from one point to another. The communication unit receives information regarding current traffic information, such as current speed of traffic flow, and traffic incidents which affect flow, such as accidents and road construction. The unit is programmed to allow the user to set a value for an alert parameter. In one embodiment, the user can select a value for an alert which if met or exceeded the program code will output an alert and make alternate routes available to the user. An alert parameter can be average speed or time. Thus, a user can select an alert value such as 10 minutes. The selected route will have projected time of arrival or projected average speed, or other parameter value based upon baseline information. As current traffic information is received the program code calculates a revised parameter, such as estimated time of arrival taking into account current traffic conditions. If the revised value of the parameter is equal to or greater than the baseline value of the parameter, plus the alert value, the program outputs an alert to the user. In one embodiment, a comparison of the alternate routes to the current route is outputted and the user can select one of the alternate routes if desired. If the revised value of the parameter does not meet or exceed the baseline value of the parameter, plus the alert value, the program will repeat the calculation at predetermined intervals with the then current traffic information. Thus, the user is alerted to changing traffic conditions that significantly impact planned travel time. Traffic information includes speed over various segments, and incidents at various segments. Incidents are events such as accidents, road construction, flooding, public events, etc.

In another embodiment, the invention provides for a dynamic road speed sensitivity function to provide current road speed information to the user. In this embodiment, the program is provided to receive inputs of current traffic information and related segments; model the current traffic information to the data in the relationship database regarding the segments, the program code determines a calculated speed for segments having reported incidents but not a reported speed. The current reported speeds calculated are then inputted and a current speed distribution is determined for the area. The speed distribution is used to determine indicator values, and the indicator values are used to assign indicators to various segments. The program can output a map illustrating the current speeds with indicators, or can display the route with the indicators applied to various segments of the route. The calculation is repeated as new traffic information is received or at selected intervals.

### BRIEF DESCRIPTION OF THE DRAWINGS

A more complete understanding of the invention and its advantages will be apparent from the following detailed description when taken in conjunction with the accompanying drawings in which:

FIG. 1 is a schematic of a navigation system in use;

FIG. 2 is a schematic representation of a navigation unit;

FIG. 3 is a front view of a navigation unit of one embodiment of the invention;

FIG. 4 is a view of one embodiment of an input screen for map route options;

FIG. 5 is a view of one embodiment of another input screen for alert values;

FIG. 6 is a view of another embodiment of an input screen for alert values;

FIG. 7 is a view of one embodiment of an alert display;

FIG. 8 is a view of one embodiment of a navigation display;

FIG. 9 is a partial flow chart of the alert and alternate route computer program;

FIG. 9a is a continuation of the flow chart of FIG. 9;

FIG. 10 is a view of one embodiment of a display comparing current route with an alternate route;

FIG. 11 is a partial flow chart of the dynamic road speed sensitivity program;

FIG. 11a is a continuation of the flow chart of FIG. 11;

FIG. 12 is a schematic representation of indicator values, indicators and an example portion of a route; and

FIG. 13 is an illustration of indicators applied to a selected route.

### DETAILED DESCRIPTION

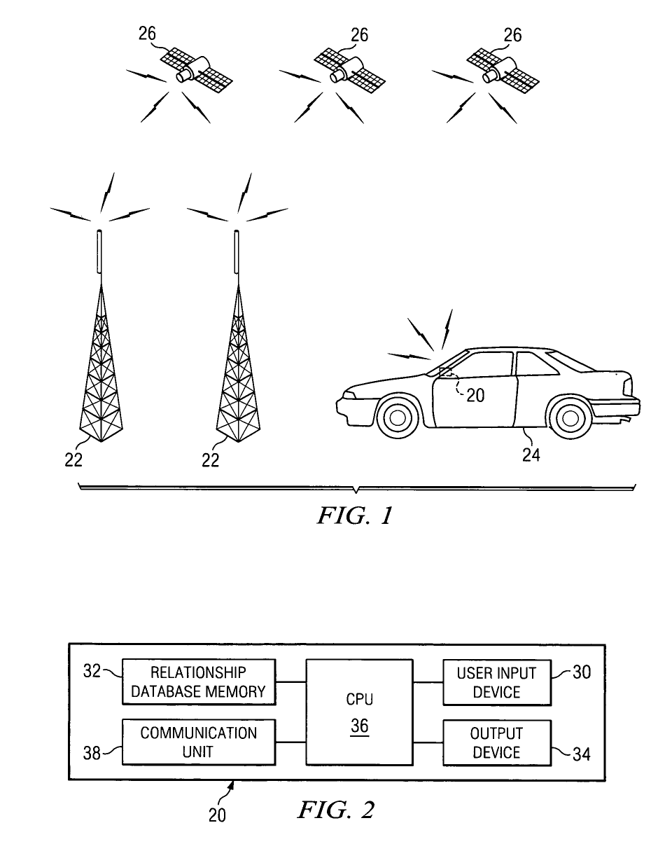

Referring to FIG. 1, in one embodiment of the invention, a navigation unit 20 is provided. A source or sources of current traffic information is utilized. Current traffic information can be real time information or information which is within a predetermined delay period, or which is within a delay period determined by changes in the conditions of the traffic. Traffic information can include speed information for road segments and incident information, such as traffic accidents, flooded roadways or intersections, road construction, etc. Incidents can be of many types as recognized by the ISO published Event List 14819-2. All or a portion of the various types of traffic information can be reported for a road segment. However, it is recognized that for some roads, current speed information may not be available. Thus current traffic information is the current information to the extent it is available. The current traffic information can be from any source providing such information. In one embodiment of the invention the source of traffic information can be radio broadcast from one or more transmission devices such as towers 22. Such services as the Total Traffic Network provided by Clear Channel or Nav Traffic provided by XM Radio can be used in the present invention. These services can use various sources of information such as Department of Transportation monitoring of traffic speed and reports of construction, police or news sources for information concerning accidents, flooding, and other road obstructions. Other sources of traffic speed can be from speeds determined by monitoring the current speed of subscribers, such as persons using navigation units, speeds over various road segments. The radio transmission device can be any other suitable transmission device such as satellite, broadcast towers, etc. The invention is not limited by the choice of a transmission system. The navigation unit 20 has a communication unit to communicate with sources to information regarding the movement and position of the navigation unit and to communicate with the source of traffic information. Since the navigation unit will typically be held and moved by the user, either while walking or driving a vehicle 24, the movement of the navigation unit 20 will correspond to the movement of the user. Positioning information is provided by any suitable source such as GPS satellites 26. Other positioning systems can be utilized such as LORAN. In a less desirable embodiment, the positioning system can be inputs received from sensors on the vehicle which output the distance traveled, turns made, and other predetermined information. These sensors are connected to the communication device to provide input to the navigation unit. Thus, travel from a known location can be monitored. This is a less desirable embodiment because of the difficulty in calibrating the sensors and the potential for false data. For example, if distance traveled is measured by wheel rotation, spinning of the wheels, inflation pressure of the tires and tire size can produce inaccurate measurements. This embodiment is less desirable because if the user incorrectly inserts his starting point, the computations will be relatively meaningless because the system computes position based on movement from a known point.

GPS service is used in the preferred embodiment. GPS data is used by a receiver, such as the present navigation unit, to compute position, velocity and time.

FIG. 2 is a schematic illustration of navigation unit 20, which in one embodiment, has a user input device 30 to receive inputs from the user. The input device can be of any type currently known or later developed. For example, the input device 30 can be a keyboard, a touch screen, a voice recognition receiver, a scanner, etc., or combination thereof. The user input device can be integral with the other components of the navigation unit 20 or can be remote from the unit such as a remote control. A processor 32 is included in the navigation unit 20. The processor 20 is a computer processor programmed or which interacts with programs to provide the navigation functions described herein. The navigation unit 20 also includes one or more output devices 34 for providing the user with output information. The output devices 34 can be any currently known device or later developed device. For example, the output devices 34 can be a visual display, an audio output, a synthesized voice output, printed output, etc., or combination thereof. The output devices 34 can be integral with the other components of the navigation unit, or can be remote. Multiple input and output devices can be utilized. While in the illustrations, the navigation unit is shown as single unit, it can be a system of connected separate units.

In a preferred embodiment, the navigation unit 20 includes relationship database 36 containing predetermined relationship information such as map information. Map information can be of many types, such as, type of roadway, intersections, posted speed limits, average actual speeds, addresses, points of interest, one way roads, direction of one way travel, compass orientation, etc. Frequently, the map data is correlated by using nodes and segments. Nodes for example, can be intersections where there are in the ability to change the direction of travel. Segments for example, would be sections of road between nodes. In addition, map information can include points of interest such as, names and locations of parks, restaurants, hospitals, etc. In addition, map information can include geographic information, includes such items as location of rivers, lakes, altitude at various locations, relief data, etc. The relationship database can be a single database, or multiple databases or memory devices. The relationship database can also include information inputted by the user as described below. The discussion of preferred embodiments is limited to various embodiments for travel on roadways, but limiting the discussion is not intended to limit the scope of the claims. The relationship database is stored on a storage media, such as a computer chip, a hard drive, DVD disks, as well as devices that may be developed in the future. The navigation unit 20 can also include another storage device in the form of random access memory for storing navigation programming and user preferences. Alternatively, the navigation program and other non map information may be stored in the relationship database with the mapping information. Preferably, the relationship database is one storage media connected directly to the navigation unit, however, the relationship database can be a remote database accessed by wireless communication.

The navigation unit 20 includes a communication unit 38. Communication unit 38 is for receiving input positioning information, for example a GPS receiver, and/or for receiving inputs from movement sensors in the vehicle. Communication unit 38 also receives inputs of current traffic information from the source providing the traffic information.

The navigation unit includes a computer program to generate a route from the map information in the relationship database 36. Computer programs to generate map or routes from one location to another location are known (routing program). The present invention utilizes any known navigation programs or later developed programs. Navigation programs can have many features such as route calculation, route guidance in the form of detailed instructions, displays of maps and routes, and display of current direction of travel and current position, and estimated time of travel. In a preferred embodiment, the navigation program includes code to consider the type of road (e.g. interstate, divided highway, street) as one factor in determining a route. This allows for the determination of a route that will include main arteries of transportation. In a preferred embodiment, the invention includes a routing program which has program code for determining a primary route based map information, program code which can take into consideration any user inputs as to preferences in determining a primary route, program code to determine a baseline value for one or more parameters, such as time of travel, estimated time of arrival, average speed, etc., of the selected route, program code for determining the current position along the route, actual values of parameters from a starting point to current positions along a route, and for displaying comparisons of two or more routes. The routing program can be stored in the relationship database, a subdirectory of the relationship, on a separate memory device, or embedded in a chip, or in any other manner currently known or later developed.

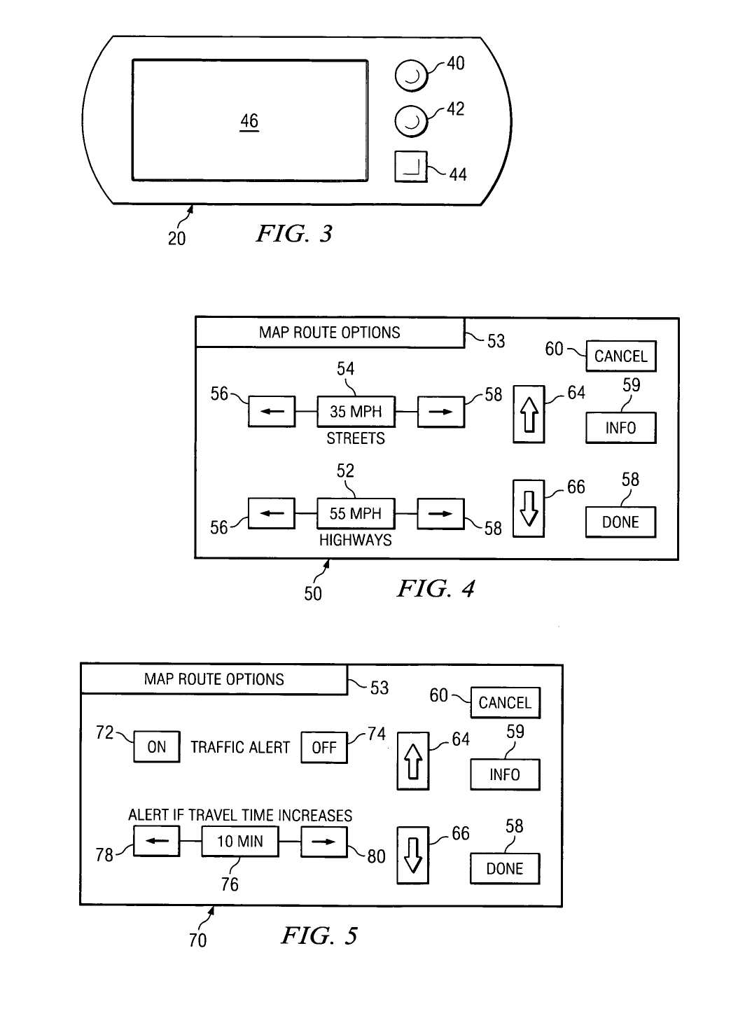

Referring to FIG. 3, one embodiment of navigation unit 20 is illustrated having user input devices in the form of buttons, such as a power button 40 to turn the unit on and off. Power can be supplied by batteries or an external power source. A mute button 42 can be provided to mute the audio output of the unit. A scroll rocker button 44 can be provided to allow the user to scroll the screen display. Display screen 46 can function as both an output means and an input means. In one embodiment, the screen 46 displays one or more screens of graphical user interfaces (GUIs) to allow user selection of various options or to input data. In one embodiment, screen 46 is a touch screen. The screen 46 can also be used to display maps, and route information. Screen 46 can be any suitable display device such as a CRT, LCD, plasma, etc., or later developed displays.

Information inputted by the user can be stored in the relationship database 36. In one embodiment, the relationship database 36 includes one of more address book folders. Thus, the user can input favorite locations, such as home, office, schools, airports, office locations of customers, or predetermined routes such as from home to office in various folders. By accessing the address book, the users select predetermined routes, destinations, etc. without inputting the raw data a second time. In another embodiment, a GUI is provided to allow the user to input preferences regarding the computation and selection of the route. These inputs can be one or more various characteristics of the route which are desired and characteristics of the route to be avoided. These characteristics can include shortest route, fastest time, freeways, toll roads, scenic routes, etc. These route characteristic inputs are used by the routing program to calculate a route to display to the user. A GUI can be provided to allow the user to compare routes, for example, to display both the fastest and the shortest route. GUIs can also be provided to access selected information in the relationship database, such as to display a list of restaurants, or hotels, or theaters, etc. In one embodiment, the GUI displays include a touch screen keypad for inputting letters and numbers, a touch screen scroll control. When multiple types of input devices are provided the user can select which ever one is more convenient, e.g. elect to use the scroll button 44, or the touch screen scroll buttons. GUIs can also be provided to allow the user to select various options regarding the type of information outputted and the manner of output.

The output device 34 can be one or more output devices. The screen 44 can provide a visual display, a speaker can provide an audio output, and more than one output device can be employed simultaneously. Various information can be outputted in any predetermined manner. A request for gas stations within 2 miles can be displayed initially as a list of the gas stations with an indication in what direction each one is located and how far away each one is. The user can then select the desired gas station and the navigation unit will display route instructions.

Utilizing the information in the relationship database in conjunction with current traffic information provides additional benefits to the user. A typical user does not need a navigation unit to travel the familiar everyday routes such as from home to the place of employment. However, the input of current traffic information to the navigation unit allows the user to determine if the normal route to work is flowing as usual. In an embodiment of the present invention, the user inputs the route from home to office in the address book. Before staring for work the user calls up the route. The user inputs an alert value if one has not been previously selected and turns on the alert function. The navigation will alert the user when current traffic information meets the alert conditions. The user can then view and select an alternate route. Thus, the user can employ the navigation to avoid their usual route when current conditions indicate there will be an abnormal delay. This permits the user to select a different route to avoid congestion, accidents, construction, etc.

FIG. 4 illustrates an input screen 50 of one embodiment of the invention providing a speed route baseline for the user to select. In this embodiment, the user is presented with speeds for streets and highways. The current selection for highway speed appears in window 52. This speed can be a default speed, such as the speed for route contained in the map information, or the last speed set by the user. In a similar manner the current speed selection for streets appears in window 54. Selection buttons 56 to decrease the speed settings are associated with each of the street and highway speed windows 54 and 52. In a like manner, selection buttons 58 to increase the speed settings are associated with each of the street and highway speed windows 54 and 52. This input allows the user to change baseline data based upon experience. For example, the baseline data for speed for a segment in the map information provided by the map data provider. Data providers in many cases provide map data to allow calculation of travel time which can be based on values assigned based on the classification of roads used. In some cases, the map information includes the posted speed limit. No matter what method and data the map information provider has used to provide a baseline speed or time of travel, the baseline values frequently do not accurately reflect actual experience. The user from experience knows that this baseline speed data does not produce an accurate representation of normal conditions. Thus, the user can insert a new base line value for speed. The new value is used to compute an estimated time of arrival, or estimated time for the trip. This allows the user to decrease speeds assigned to segments to account for city congestion and increase speeds assigned to segments to lightly travel remote highways. The display can include a title box 53 for a description of the screen. Thus, a user is familiar with a particular route; the user can select speed settings which produce estimated travel times more closely correlating with experience in a given area. Once selected, the user pushes the done button 58 to accept the change. If the user has made a mistake the cancel button 60 may be pressed. Touch input screen 50 can also include a scroll up button 64 and a scroll down button 66 to advance to different screens. The speed settings are inputted into the program code when it is determining the primary route to a selected destination. In one embodiment, the screen includes an information button 59, which when selected will display to the user information about the functions and purpose of the screen and how to use it.

FIG. 5 show an input screen 70 for one embodiment in which the user can select to turn on or off the traffic alert function by pressing either on button 72 or off button 74. If the user turns the traffic alert function on, the user can select a value at which the program will generate an alert. In the illustrated embodiment of FIG. 5, the alert value is time variation over the baseline time. Time alert window 76 displays the default of last set time value for when an alert regarding traffic conditions should be displayed. This time value can be a default value or the last value inputted by the user. In a similar fashion as with reference to FIG. 4, buttons are provided to allow the user to change the set time by pressing either time decrease button 78 or time increase button 80. Done button 58, cancel button 60, scroll buttons 64 and 66 are provided as with screen 52 in FIG. 4. The base line time is the time computed from the relationship database information taking into consideration any user changes inputted such as discussed with reference to FIG. 4, which can be computed in a number of different manners. For example, assuming the user has not inputted any changes, the base line time can be computed by the routing program from the distance of each segment, and the posted speed limit for each segment, and it can, if desired, further take into account delays caused by traffic control devices such as stop lights and stop signs. Thus, the base line time may not accurately reflect the normal actual time of travel at various conditions. This alert feature allows the user to select a value between the base line time and the computed estimated time of arrival, or time for the trip, at which the user will be notified of alternate routes. The computed estimated time of arrival takes into account, as one variable, the actual traffic conditions are inputted to the navigation unit. This function allows the user to set the alert value based on their experience. As an example, the base time for the trip from the user's home to place of employment over a certain route could be 30 minutes. The user knows from experience over days and months that the trip over that route usually takes 40 to 45 minutes in the morning when there are no unusual traffic problems. Thus, the user can set the alert function to advice of alternate routes when the computed estimated time of arrival exceeds the normal travel time by a selected amount. In this example, the route parameter being considered is the time of travel for the route. In a similar fashion, other parameters can be used such as average speed for the route.

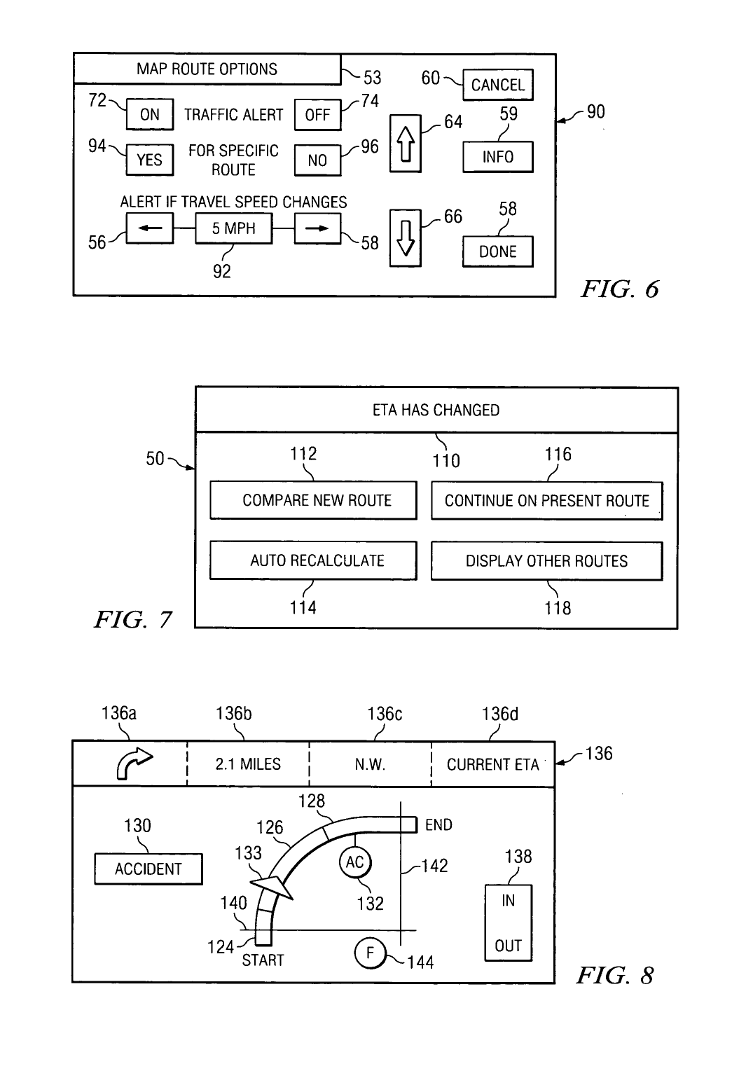

In another embodiment of the invention as illustrated in FIG. 6, the user is presented input screen 90. Input screen 90 contains some of the same buttons as screen 70 which perform the same function as described above, such as buttons 64, 66, 72, and 74. In this embodiment the alert value is speed. Window 92 displays the alert speed. When the average computed speed for the current trip falls below the base line value by the selected alert value, the user will be alerted and alternative routes computed. The speed setting can be changed by pressing decrease button 56 or increase button 58. In this embodiment the user is also presented the option to select a specific route. The user can select to apply different alerts to settings to different specific routes stored which the user has previously stored in memory by pressing yes button 94 or no button 96. If the user selects the yes button 94, the user is presented with a prompt for input of the specific route. In one embodiment this prompt is in the form of a browse button 98. By selecting to browse a listing, the user saved routes will appear. The user then selects the route of interest. After selecting the route of interest, the user then selected the alert value to apply to that route. This allows the user to select a particular route, for example, from home to place of employment, and set an alert value based on experience. Thus, the user is able to input alert values specific to each designated route which has been saved. Thus, the alert values for the trip from home to office can be different from the alert value for the trip from home to the vacation home. As to unspecified routes, the user can select a different value for the alert.

The value parameters for triggering an alert are not limited to those illustrated in the figures. Other value parameters for alerts can be used such as if the computed estimated time for travel exceeds the base line value by a certain percentage. When the difference between the base line value and the current computed value reaches or exceeds the alert value, in one embodiment screen 50 displays an alert to the user. As illustrated in FIG. 7 the program code can generate a display which can include a message box 110 displaying any predetermined message, such as “ETA (estimate time of arrival) has changed”, “accident ahead”, etc. When the alert value has been met or exceeded the program code generates a primary alternate route. In one embodiment, as illustrated in FIG. 7, the screen displays the message box, and the computer code also generates a display of touch screen buttons, these buttons can include a compare route button 112, a recalculate button 114, and a continue button 1 16. When the user presses the compare route button 1 12, the program code generates a display having the original route and the primary alternate route displayed. If the user desires to proceed with the primary alternate route, the user can select the continue button 116. When the user selects the recalculate button 114, the unit recalculates the current route based on current traffic information. The user can also request the display of additional alternate routes. In a preferred embodiment, the alternate routes are calculated using previously imputed user criteria for road characteristics, such as to avoid toll roads or other characteristics. If the user does not desire to use the primary alternate route, the user can have the program code display one or more other alternative routes by pressing the other alternative button 118. Although the user inputs are illustrated on one screen, they can be presented in any desired alternative fashion, or by other types of output devices such as voice recognition, switches, keypad, etc.

FIG. 8 illustrates a display 120 of one embodiment which shows the current route 122. In a preferred embodiment, the route is displayed in segments such as segments 124, 126, and 128. Segments 124, 126, 128 are preferably color coded to display current traffic flow. For example, a green segment means traffic is flowing at normal rates, a yellow segment means that traffic is flowing below normal rates, and a red segment means traffic flow is stopped or very slow. Three colors are used for purposes of explanation but more or fewer colors can be used. The color of the segments change as the input of the current traffic conditions is updated. It is not necessary to use color and other methods for visual differentiation can be used. Screen 120 can also contain a message box 130 to display predetermined information. For example, when a traffic incident is inputted, such as an accident, a description of the incident can be displayed such as “accident” as illustrated in box 130. Also, the program code can display the location of the incident on the route by a suitable icon 132. Traffic incidents can include such items as accidents, road construction, etc. The screen display can include a navigation box 136 to display navigation information such as the direction of the next movement in box 136a, the distance to the next movement 136b, the current direction of travel, 136c, and the estimated time of arrival 136d. The information content of the navigation box 136 can include type of predetermined information, and FIG. 8 is merely illustrative of one selection of navigation information. A zoom button 138 is preferably provided to allow the user to zoom in or out of the map of the route. The display can also include displays of surrounding streets 140 and 142, as well as various icons such as icon 144 signifying the location of gas or fuel station. In a preferred embodiment, the screen also display an icon 133 showing the current location of the user along the route.

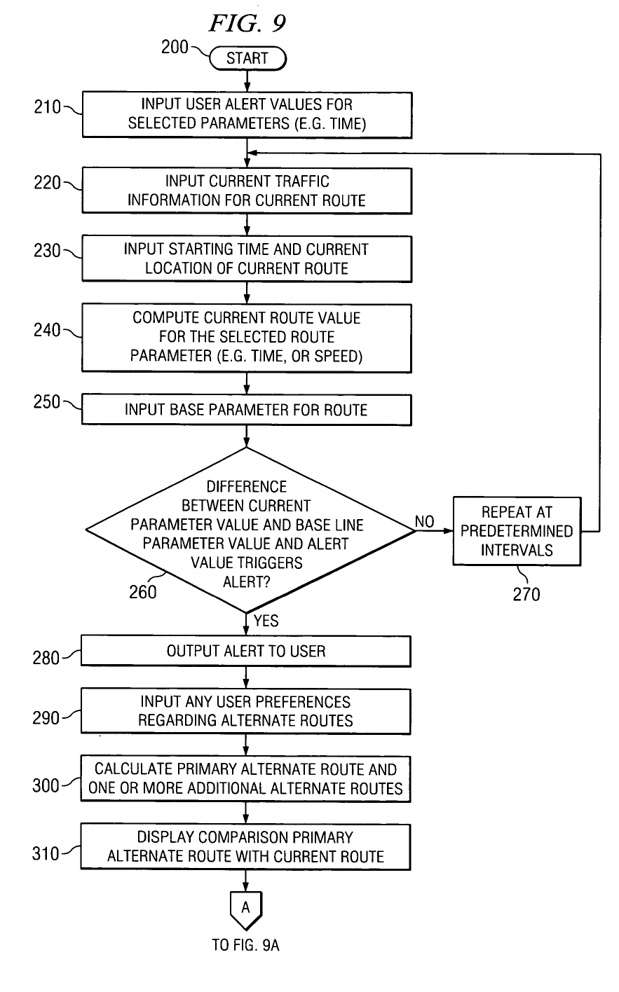

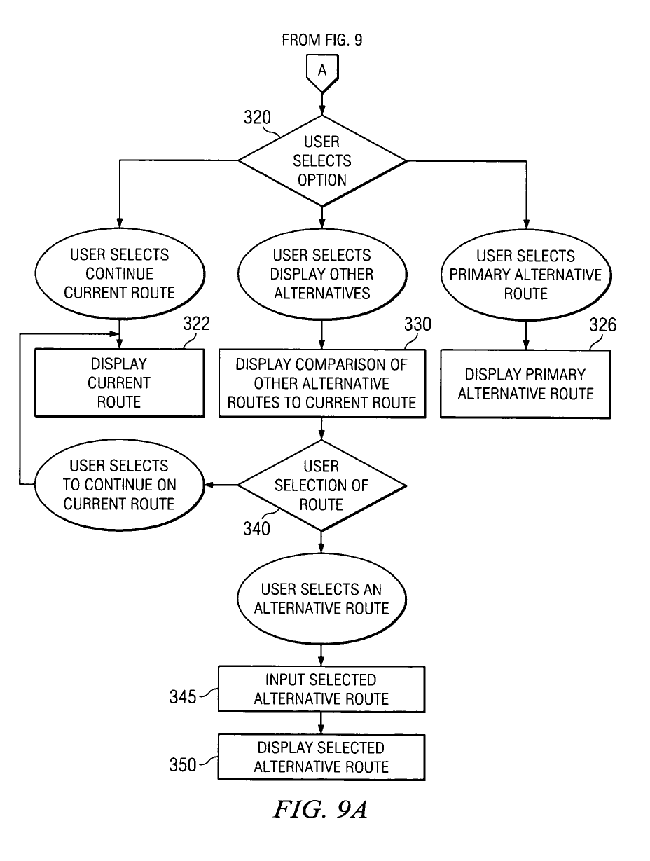

FIG. 9 is a flow sheet of the alert program to be used in conjunction with the routing program. The user starts the program, box 200, and program code receives the user inputted alert values for selected parameters, box 210. These inputs can be current inputs, or the retrieval of stored previously inputted values from the database. The program code then receives inputs of the current traffic information for the current route from a source such as XM radio. The program code receives inputted data for computing a selected parameter, such as total time of trip, current ETA, current average speed box 230. The program code then computes the current route value for the selected parameter, box 240. The program code receives inputs to determine a base line value for the parameter, box 250. As discussed above, these baseline values are determined from data in the relationship database and user inputs, if any, changing the base line values. The program code then compares the base line value for the parameter and the alert value for the parameter against the current value of the parameter, box 260. Depending on the base line parameter selected, the program code determines the difference between the current values of the parameter varies from the base line taken together with the alert value in a manner that indicates an alert output should be outputted. For example, when the selected parameter, such as time for the trip or estimated time of arrival, is one that increases if there are traffic delays (increasing parameter), base line value if the current value for the parameter does not exceed the baseline value and the alert value, the program code repeats the computation at predetermined intervals, box 270. These predetermined intervals can be a preset specific time period, or can be the time interval between updated current traffic conditions, or can be initiated by reception of new traffic information. In the event the current parameter value exceeds the baseline value and the alert value, the program code generates an output to the user, box 280. Correspondingly, when the selected parameter is one that decreases (decreasing parameter), such as average speed over the route, when there are delays, then the program code determines if the current value of the parameter is less than the baseline line value for the parameter reduced by the alert value for the parameter.

Preferences for alternate routes, if any, are inputted by the program code, box 290. These can be previously inputted preferences that have been stored in memory or can be current inputs from the user. A primary alternate route is calculated by the program code as well as one or more other alternative routes, box 300. The program code then displays a comparison of the primary alternative route with the current route, box 310. Program code is provided to allow the user to input a request for the other alternate routes, box 320. If the user selects to continue on the current route, program code displays the current route, box 322. In the event the user selects the primary alternate route, the program code displays the primary alternate route, box 326. The display of the primary alternative route can contain navigation information such as discussed above in relation to items 136a, 136b, 136c, and 136d. If the user selects to view other alternative routes, then they are then displayed in comparison to the current route by the program code, box 330. Program code is provided to allow the user to input a selection one of the alternate routes, box 340. The selected alternate route is inputted, box 345 and the program code will then be outputted the selected alternate route to the user, box 350.

The calculation of the primary alternate route can include any predetermined conditions. In one embodiment, if the current traffic condition inputted is an accident, the primary alternate route can be a detour around the accident location on streets. In another embodiment, the primary alternate route will be the best alternative freeway route which is a freeway. These conditions can be integral in the program code, or be preferences to be selected by the user.

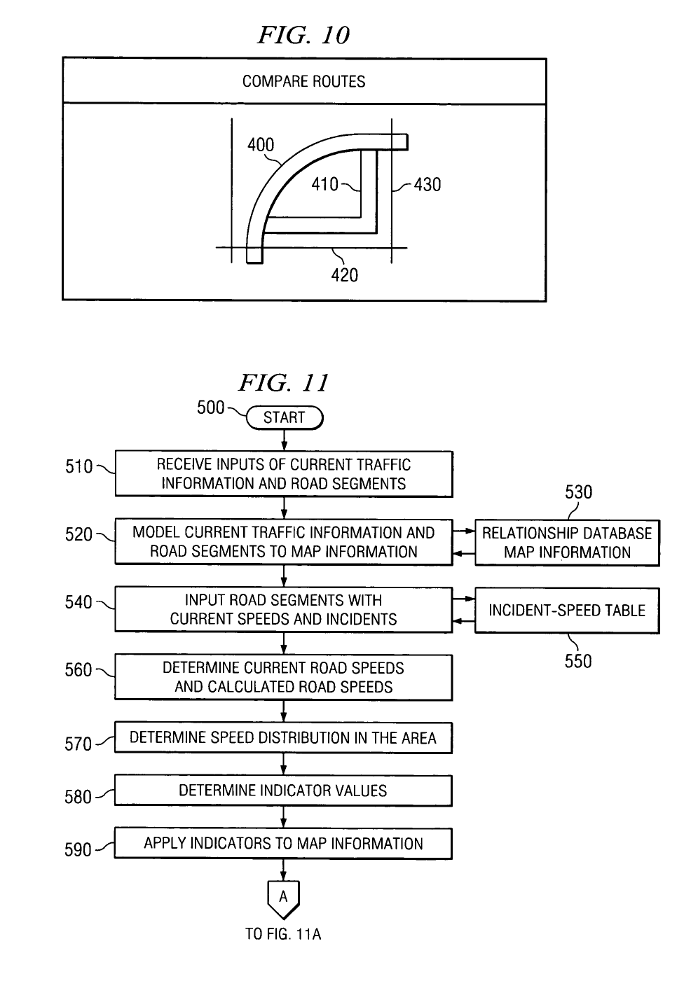

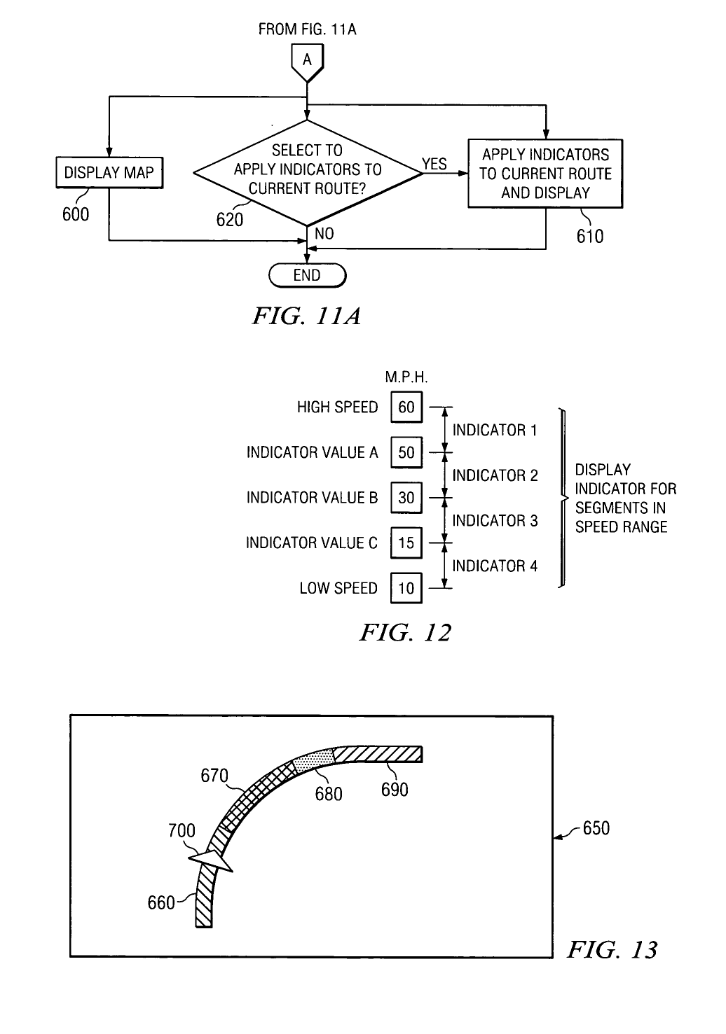

When the user selects the compare new route button 112 (FIG. 7) the program code, box 330, causes an output which is preferably a visual output having both the current route and one or more of the alternate routes overlaid as illustrated in FIG. 10. In FIG. 10, the current route 400 is shown, with one or more of the alternate routes 410. The comparison display preferable also shows other streets 420 and 430 in the area.

In another embodiment of the invention, a dynamic road speed sensitivity program is provided. The program is started, box 500. The program receives inputs of traffic information and segments to which the traffic information applies, box 5 10. The program code then models the traffic information, box 520 to the relationship database 530, in a preferred embodiment the road segment is provided to the database which returns to the program the segment details, box 520. The traffic information which can include current road speed and/or incidents is then used to determine current road speeds for the segments. The current speeds and incidents are inputted into the program, box 540. In the event no current speed has been provided, but only an incident has been reported, such as an accident, the incident is sent to an incident speed table 550. The incident speed table 550 is a table which assigns a predetermined reduction in the baseline speed provided by the relationship database. For example, if the incident is an accident blocking two lanes of a three lane road, the baseline speed for the segment is reduced by 75%, or other predetermined amount, the program code then computes a calculated current speed for the segment, box 560. Other and additional speed reductions for other types of incidents can be provided. Also, incidents of a particular type, such as accidents, can have different speed reductions for different levels of severity of the incident. The current speeds and the calculated speeds and map segment information are inputted and used by the program code to determine a speed distribution in the area, box 570. The area is any predetermined area. In a preferred embodiment, it is an area in the proximity of the navigation unit. The area can also correspond to the area defined by the road segments for which current traffic information has been received. The program code determines the speed distribution, for example from 10 miles per hour to 60 miles an hour and then assigns current indicator values in a predetermined manner. These current indicator values are used for determining which indicator to output for each segment. For example, one can determine that three indicators are desired to identify four indicators. The indicator values can be values assigned by a predetermined relationship. For, example, assume the current speed distribution is 10 to 60 miles per hour; three indicator values can be selected to provide for four indicators. The program code determines the indicator values, box 580, for example, indicator values for the 10-60 miles per hour distribution can be 15 miles per hour, 30 miles per hour, and 50 miles per hour. Thus, a first indicator is assigned to signify speeds at 50 miles per hour or greater, a second indicator is assigned to signify speeds of 30 miles per hour to 50 miles per hour, a third indicator is assigned to signify speeds of 15 miles per hour to 30 miles per hour, and a fourth indicator is assigned to signify speeds of less than 15 miles per hour. The number of indicators to be used is a matter of choice. This example is graphically shown in FIG. 12. In another embodiment, the number of indicators can be preset depending on the size of the speed distribution. Where the speed distribution is small, for example a variation of 20 miles per hour, two indicators can be sufficient, where the speed distribution is great, for example a variation of 50 miles per hour then four indicators can be useful. Thus, in one embodiment the program code determines the size of the speed distribution and determines the number of current indicator values based upon the size of the speed distribution. The program code sets the current indictor values and assigns indicators to the segments of the map information, box 590. The program code can automatically output a map with the current speeds of various road segments indicated, box 600. Program code is also provided to correlate the current speeds and indicators to the segments of the route which has been selected by the user, box 610. The program code in conjunction with the routing program can automatically apply the data to the route selected by the user and output to a user, a map or other output displaying the indicators for various portions of the route. Alternatively, a program code can be provided which allows the user to select whether to apply the current speed information to the use's route, box 620. If the user selects to have the indicators applied the program displays the route, 610.

Referring to FIG. 13, screen 650 shows an illustration of a route displayed with four portions 660, 670, 680, and 690 along a route having a speed distribution of from 10 miles per hour to 60 miles per hour has been computed. The program code has assigned three current indicator values 15, miles per hour, 30 miles per hour and 50 miles per hour. Thus, four indicators are assigned as described above. In a preferred embodiment, the indicators are different colors, one for each indicator; however, other indicators can be used such as cross hatching, numbers, letters, words, etc. As illustrated, portion 660 has a serpentine line on the route representing indicator 2 for a speed between 30 and 50 miles per hour on that portion. Portion 670 has a cross hatch on the route representing indicator 2 for a speed between 15 and 30 miles per hour on that portion. Portion 680 has a solid fill in on the route representing indicator 1 for a speed less than miles per hour on that portion. Portion 690 has a single hatch pattern on the route representing indicator 1 for a speed above 50 miles per hour on that portion. Preferably, the display includes an icon 700 indicating the current position of the user along the route.

The road speed sensitivity process described above is repeated at predetermined intervals or continuously as data is received. Thus, the output to the user changes as traffic information changes. In another embodiment, program code can be provided to store the time an incident for a road segment is first reported and to maintain the incident for a predetermined time. For example, an accident on a segment is received, the program code can have an assigned predetermined time which it will carry the incident forward and after which it ignores the incident. After a set period of time, the program code resets and any subsequent input of an incident for that road segment will be recognized. This can be useful where reports of accidents are repeated after the accident has been cleared.

1. A navigation unit comprising:
a memory device containing a database of map information;
a communication unit;
a user input device;
an output device;
a processing unit having
(a) program code to receive inputs from
(i) said communication unit of information from which the speed, distance traveled and direction of travel can be computed, and information from which traffic information along a selected route can be inputted,
(ii) said user input device of information related to user preferences and user selections concerning, starting point, and destination;
(b) program code for determining a primary route based on user inputs and map data from said map database;
(c) program code for determining current location and time of travel along the selected route;
(d) program code for sending an alert to said output device when it is determined that the difference between the current value of the parameter varies from the base line value of the parameter taken together with the alert value in a manner that indicates an alert output should be outputted, and
(e) program code to calculate at least two additional routes to the selected destination.

2. A navigation unit of claim 1 further comprising:
(f) program code to display one or more alternative routes.

3. A navigation system comprising
a processor programmed to calculate
(a) a route from a starting point to a destination;
(b) a baseline value for a parameter of travel;
(c) the current position of along said route and a current actual parameter value to the current position;
(d) calculate a current value of a parameter for said route based upon current actual parameter value and current traffic information;
(e) whether the difference between said current value of the parameter varies from the base line value of said parameter taken together with the alert value for said parameter in a manner that indicates an alert output should be outputted; and
(f) one or more alternate routes from the current position when the current parameter indicates an alert.

4. A navigation system of claim 3 wherein said parameter is time.

5. A navigation system of claim 3 wherein said parameter is average speed.

6. A navigation system of claim 3 wherein said processor performs the calculation of current estimate upon input of current traffic information.

7. A navigation system comprising:
a processor programmed to calculate (a) a route from a starting point to a destination, (b) a baseline time of travel for traveling said route, (c) the current position of along said route and current actual time of travel along said route, (d) a current estimated time for said route based upon actual time of travel and current traffic information, (e) whether the current estimated time of travel is equal to or greater than the sum of the baseline time and the alert value, (f) one or more alternate routes from the current location to said destination if said current estimated time of travel is equal to or greater than the sum or the baseline time and the alert value.

8. A computer program for use with a navigation program capable of calculating a route from a starting point to a destination, an estimated time of travel, the current location along the route and the actual values for parameters from the starting point to the current location, comprising:
(a) means to compute a current value of the parameter based on current traffic information for travel from the starting point to the current location, and an estimate of the remaining travel time from the current location to the destination; and
(b) means to determine whether the difference between the current value of the parameter varies from the base line value of the parameter taken together with the alert value in a manner that indicates an alert output should be outputted.

9. A computer program for use with a navigation program capable of calculating a route from a starting point to a destination, an estimated time of travel, the current location along the route and the actual values for parameters from the starting point to the current location, and a baseline parameter for said route comprising:
(a) means to compute a current estimated value of the parameter based on actual parameter date for travel from the starting point to the current location, and an estimate of the remaining travel time from the current location to the destination; and
(b) means to determine whether the current estimated value of the parameter is equal to or greater than the baseline estimated value of the parameter and the alert value for the parameter.

10. A computer program for use with a navigation program capable of calculating a route from a starting point to a destination, an estimated time of travel, the current location along the route and the actual values for parameters from the starting point to the current location, and a baseline parameter for said route comprising means for applying current speed and calculated speed to said route.

11. A navigation unit comprising:
a memory device containing a database of map information;
a communication unit;
a user input device;
an output device;
a processing unit having
(a) program code to receive inputs from
(i) said communication unit of information from which the speed, distance traveled, current location, time of travel and direction of travel can be computed; and information from which traffic information along a selected route can be inputted,
(ii) said user input device of information related to user preferences and user selections including, an alert value of a parameter, starting point, and destination;
(b) program code for determining a primary route and a baseline value of a parameter;
(c) program code for determining time of travel along the primary route;
(d) program code for sending an alert to said output device when it is determined that the difference between the current value of the parameter varies from the base line value of the parameter taken together with the alert value in a manner that indicates an alert should be outputted; and
(e) program code to calculate at least two additional routes to the selected destination.

12. A navigation unit of claim 11 further comprising:
(f) program code to display one or more alternative routes.

13. A navigation unit of claim 12 further comprising:
(g) program code to generate an output comparing said primary route with said one or more alternative routes.

14. A navigation unit of claim 11 wherein said parameter is average speed.

15. A navigation unit of claim 11 wherein said parameter is time.

16. A navigation unit of claim 11 wherein said user input information includes base line values for speed.

17. A navigation unit of claim 11 further comprising program code to store one or more primary routes for later recall by the user.

18. A computer program comprising:
means to receive inputs of current traffic information including current speeds and incidents;
means to model current traffic information;
means to calculate a calculated road speed;
means to determine a speed distribution in an area;
means to assign indicators for predetermined ranges of said speed distribution; and
means to repeat the process.

19. A method of providing alternative navigation information to a user comprising:
(a) providing a database of map information, said database including sufficient data to calculate a primary route from a starting point to an end point, and to determine an estimated value of a parameter of travel over said primary route;
(b) providing input of current traffic information along said primary route;
(c) providing input of user values of an alert value for said parameter;
(d) calculating the current estimate value of a parameter of travel over said primary route based upon current traffic information; and
(e) providing an alert to the user when said current estimate value of a parameter of travel together with the alert value indicates that an alert should be provided.

20. A method of claim 19 further comprising:
calculating one or more alternate routes to the said point from the current position based upon current traffic information.
